(19) United States
(12) Patent Application Publication
(10) Pub. No.: US 2003/0029250 A1
(43) Pub. Date: Feb. 13, 2003

(54) Electromagnetic flowmeter

(76) Inventors: Ray Keech, Stroud (GB); Alistair Vickers, Stroud (GB)

Correspondence Address: Martin G. Linihan, Hodgson Russ LLP, Suite 2000, One M&T Plaza, Buffalo, NY, 14203-2391, US

(21) Appl. No.: 10/187,512

(22) Filed: Jul. 1, 2002

(30) Foreign Application Priority Data
Jul. 2, 2001 (GB) GB0116167.8

(51) Int. Cl. G01F 1/60

(52) U.S. Cl. 73/861.17

(57) ABSTRACT

In an AC flowmeter, a method of obtaining phase sensitive measurement is disclosed, which can dramatically reduce the effect of unwanted signals. According to the invention the output of the electromagnetic flowmeter (which flowmeter is arranged to be excited at an excitation frequency selected from a range of possible excitation frequencies) is corrected. The method comprises

storing information concerning the estimated phase of an unwanted component of the output signal for a plurality of excitation frequencies; and

correcting the output signal to reduce the unwanted component based on the stored information concerning the phase of the unwanted component at the excitation frequency in use.

The present invention relates to electromagnetic flowmeters.

Electromagnetic flowmeters are well-known instruments for obtaining a measure of flow rate of a flowing fluid. Very briefly, electromagnetic flowmeters operate, as is well known, by passing a current through a coil to generate a magnetic field and detecting an electro-motive force, measured in volts, induced in a fluid passing through the field. The output voltage, E, is proportional to the product of the field, B, and flow velocity, v, and thus:

E=k1.B.v (equation 1).

It is generally assumed that the magnetic field strength in the coil is linearly proportional to the current, I, flowing in the coil so that:

B=k2.I (equation 2).

Thus, the output signal is proportional to the product of current and velocity, and can be expressed by substitution for B from equation (2) into equation (1) as:

E=k1.k2.I.v. (equation 3).

Flowmeters have been used for many years and work well. However, there are a number of problems associated with obtaining optimum results and many of these have been addressed in the past.

AC and DC flowmeters are known in the art, AC flowmeters using an AC current to drive the field generating coils and DC flowmeters using a direct current or a switched direct current to drive th field generating coils. A disadvantage of DC flowmeters is that they can be less accurate or more prone to flow-induced noise than a comparable AC flowmeter. On the other hand, a problem encountered with AC flowmeters is that eddy currents are induced in the body of the flowmeter or adjacent structure. The present invention is particularly concerned with AC flowmeters.

Any current induced in the metal components, such as the pipework and magnetic field circuit or directly in the electrode wires can produce an unwanted component in the measured signal from the electrode, which signal should ideally only reflect the flow being measured. In an AC flowmeter the unwanted signal is normally present in phase quadrature (at 90°) to the wanted signal and so by appropriate measurement techniques the effect of this unwanted signal can normally be minimised. For example, in the case of an AC excitation signal, the use of a phase sensitive detector should eliminate the quadrature component.

U.S. Pat. No. 4,709,583 recognises this problem, but takes a different approach and suggests using a pulsed magnetic field to minimise the effect of eddy current signals.

We have appreciated that phase sensitive measurement can dramatically reduce the effect of unwanted signals and we propose that the electrode signal be filtered, for example by multiplying, based on a signal carrying information concerning the phase of the field induced in the fluid. In a simplest implementation, the electrode output signal can be multiplied by a reference signal based on the current supply to the coils; this will minimise the effect of signals which are at 90° to the current supply to the coil and will substantially eliminate the quadrature components.

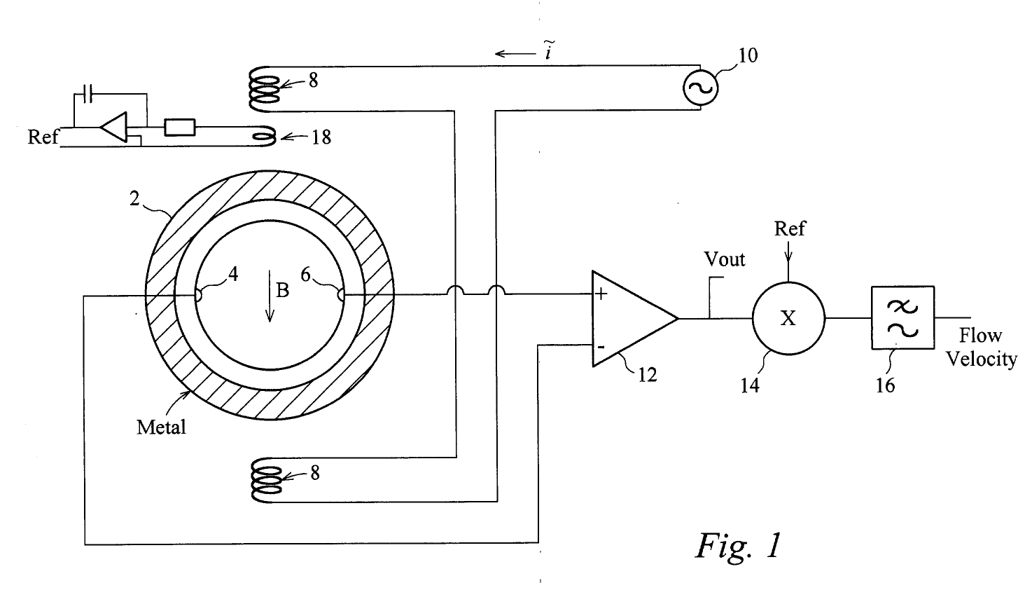

In an improved implementation, we have proposed that the field generated by the coils is sensed by a flux sensor and this is used to provide a reference signal. FIG. 1 schematically depicts a flowmeter incorporating this enhancement. These techniques rely on enhancing the output accuracy by correlating the output signal with the actual field which generates that signal and greatly improve accuracy. However, we have found that these techniques do not entirely eliminate unwanted signals, in particular zero errors can be difficult to eliminate if higher frequency measurements are taken.

In investigations pursuant to the invention, we have appreciated that, although the unwanted component is generally in quadrature to the wanted signal, careful examination of a practical flowmeter reveals that it is not, in practice, precisely in quadrature. Normally small discrepancies will be accounted for in the calibration of the flow meter as the phase sensitive detection will normally be set up to reject the unwanted component, so this small discrepancy will normally go unnoticed. However, extensive investigations have revealed that the phase of the unwanted component in practice varies with frequency. Conventionally, flowmeters tend to operate at a fixed frequency so, again, this variation would tend to go unnoticed if the meter is calibrated at a single fixed frequency. More recently, studies by the applicant have shown that it may be desirable to operate a flowmeter at a range of frequencies or at a variable frequency and that, in certain regimes, this can give rise to better power efficiency, noise immunity and/or measurement accuracy. For highly accurate meters, the residual quadrature component, which is not fully eliminated by known techniques, may cause inaccuracies in measurement.

Pursuant to the invention, it has been appreciated that the quadrature component has a predicable frequency dependence. It has been appreciated that this can be stored and used to provide a more accurate compensation for this unwanted component.

According to a first aspect, the invention provides a method of correcting the output of an electromagnetic flowmeter which flowmeter is arranged to be excited at an excitation frequency selected from a range of possible excitation frequencies, the method comprising:

storing information concerning the estimated phase of an unwanted component of the output signal for a plurality of excitation frequencies; and

correcting the output signal to reduce the unwanted component based on the stored information concerning the phase of the unwanted component at the excitation frequency in use.

The stored information may be derived from information stored for a particular design of flowmeter, in a case where the meters are mass produced within reasonable tolerances.

In certain cases the information may be derived computationally based on expected flowmeter properties. However, it is difficult to model the behaviour of a practical flowmeter with sufficient accuracy to derive this calculation accurately in most cases.

In one preferred implementation, the variation of phase of the unwanted signal with frequency is obtained by direct measurement.

In one embodiment, the phase of the signal is measured during a calibration process by inserting a search coil into the bore of the flowmeter.

In another embodiment, the phase variation of the unwanted signal is measured using the flow sensing electrodes; at zero flow, the electrode signal should comprise only the unwanted signal.

Preferably, the method of storing the information comprises sweeping the excitation frequency across a range of desired operating frequencies and recording a plurality of measures of phase of the unwanted signal across the range of frequencies.

Preferably in the step of correcting the output signal, for frequencies which do not correspond exactly to a frequency for which a phase of measurement is stored, an estimated value of phase of the unwanted signal is obtained by interpolation. It has been found that linear interpolation may give sufficiently accurate results.

Most preferably, correcting comprises measuring the electrode signal at 90 degrees to the estimated phase of the unwanted signal component based on the stored information. It will be noted that, at first sight, this may not appear desirable as it the measurement phase may not correspond exactly to the excitation signal phase. However, this can effectively eliminate the unwanted signal, leading to better zero accuracy and the improvement gained in this respect is generally better than the degradation due to the (small) loss of precise alignment with the excitation signal.

In a preferred implementation, the measured component is corrected to compensate for not being precisely aligned; this can conveniently be achieved by dividing the magnitude of the measured signal by the cosine of a correction angle corresponding to the difference between the measurement angle and the excitation angle. The correction angle (or a derived value for use in correction, for example cosine or reciprocal cosine of the correction angle) may be stored or may be derived from the existing angle information stored.

In another aspect, the invention provides an electromagnetic flowmeter having field generating coils for generating a magnetic field in a conduit;

a source of excitation coupled to the field generation coils arranged to produce excitation at at least one frequency;

potential sensing electrodes positioned in the conduit to sense potential developed across a fluid in the conduit; characterised by

means for storing information concerning the estimated phase of an unwanted signal component at a plurality of excitation frequencies; and

means for processing the electrode signal to reject the unwanted signal component based on the stored information.

The invention may be implemented in software in a suitably programmed or programmable flowmeter, for example by appropriate programming of a Digital Signal Processor (DSP) of a flowmeter.

An embodiment of the invention will now be described, by way of example, with reference to the accompanying drawings in which:

FIG. 1 is a schematic overview of an electromagnetic flowmeter; and

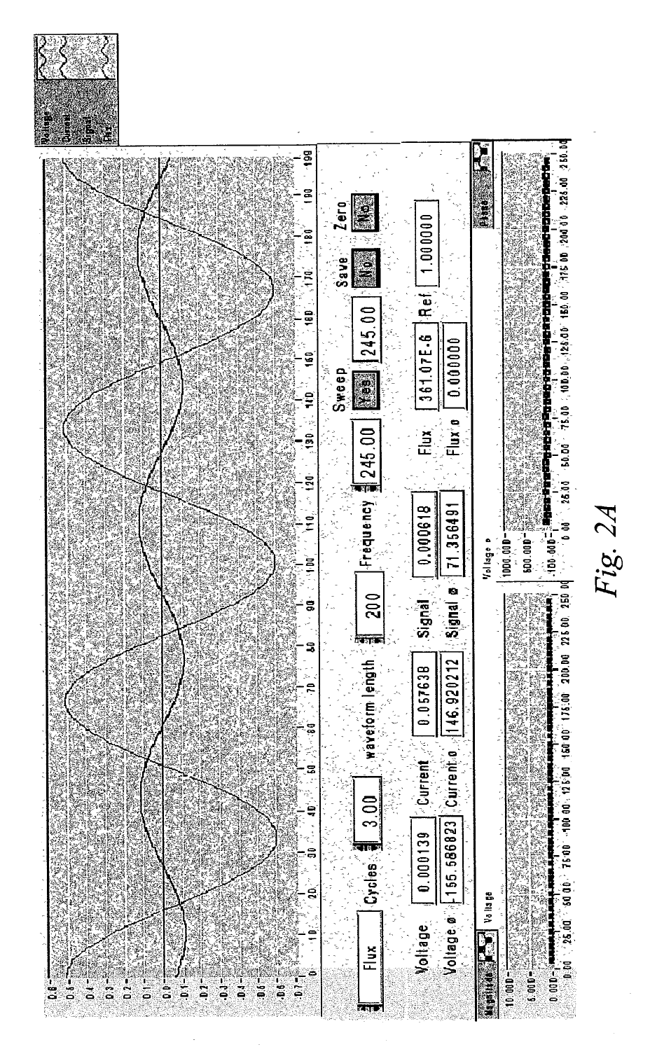

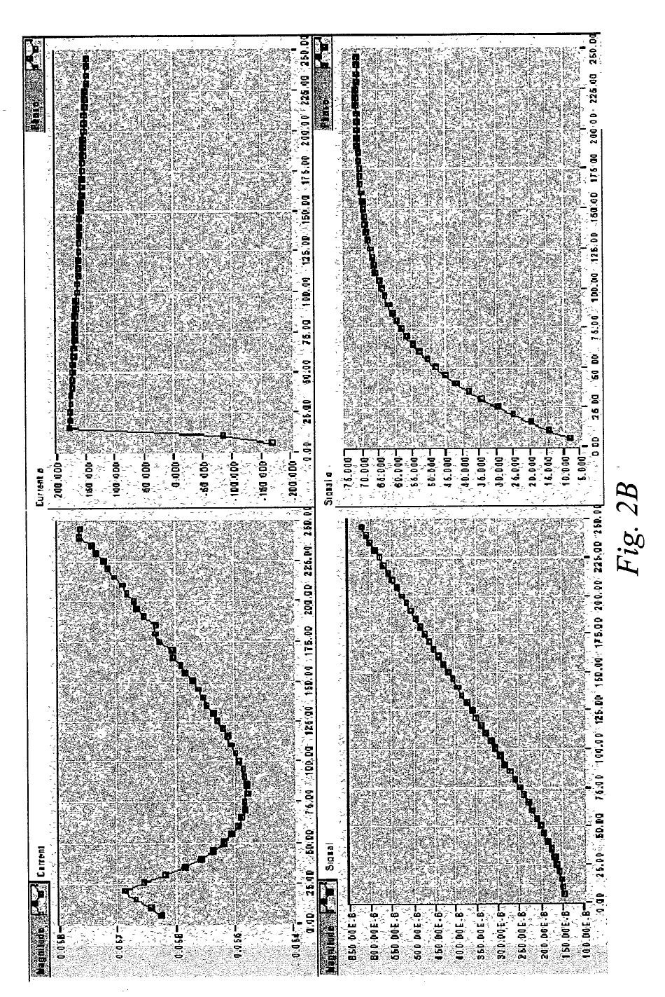

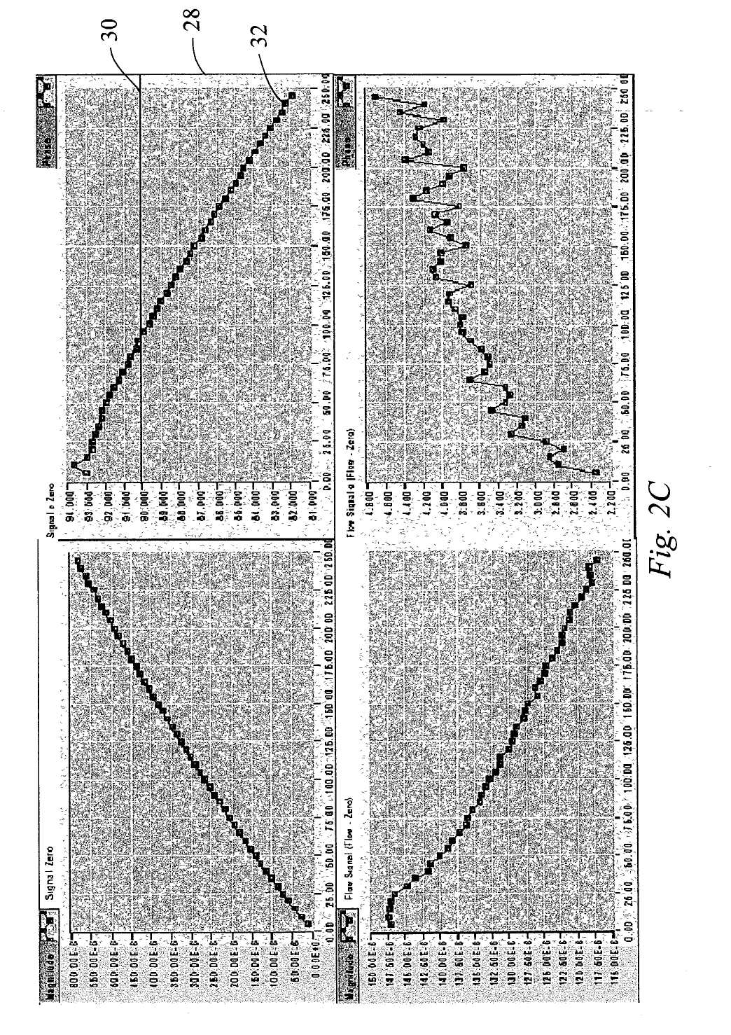

FIG. 2 shows analysis data produced in accordance with a calibration procedure according to the invention

The flow meter shown in FIG. 1 comprises a tubular conduit 2 at whose inner surface sensing electrodes 4 and 6 are arranged at diametrically opposite positions. The voltage between electrodes 4 and 6 is processed by amplifier 12 to provide an indication of flow rate.

A magnetic field B is generated by field coils 8 supplied with current from AC current source 10 such that the direction of the magnetic field is orthogonal to the direction of the flow and to a line connecting sensing electrodes 4 and 6.

Amplifier 12 provides an output Vₒᵤₜ. In order to reduce the unwanted component the output from amplifier 12 is multiplied at multiplier 14 with a detection signal. This detection signal has a relatively high value when the wanted signal has a high value and a relatively low value when the unwanted quadrature signal has a relatively high value. Thus the wanted signal Vₒᵤₜ is enhanced whilst the unwanted quadrature signal is rejected.

The detection signal can simply be a measure of the current supplied to field coils 8 by current source 10. However, as illustrated in FIG. 2, a small delay exists between the current i and the magnetic field B, and hence using a measure of the current i as detection signal may not provide optimum results.

It is therefore preferred, as illustrated in FIG. 1, to employ a flux sensor 18 (or search coil) to detect the momentary value of the magnetic field B and to generate the detection signal therefrom, by circuitry schematically shown in FIG. 1. Suitable circuit configurations will be known to one skilled in the art.

The detection signal may not be generated during actual measurement, but obtained in advance of the measurement and stored in suitable memory.

As has been mentioned above, the unwanted “quadrature” signal is not precisely in quadrature to the wanted signal Vₒᵤₜ. It is therefore preferred to link the detection signal to the phase of the quadrature signal rather than to the phase of the wanted signal Vₒᵤₜ. Hence, pursuant to a preferred embodiment, the detection signal is generated such that its phase is at 90° with respect to the phase of the quadrature signal and this will usually mean that it is not precisely in phase with the wanted signal Vₒᵤₜ. If the detection signal is not in phase with the wanted signal, the measured voltage may be corrected by dividing by the cos of the difference in phase between the wanted signal and the detection signal.

Prior to actual measurement the flow meter may be operated at zero flow, and any output obtained then should correspond to the quadrature signal. This enables the generation and storage of the phase of the detection signal appropriate for the particular frequency used. This is illustrated in FIG. 2, graph 28, which was recorded in the absence of flow. Line 32 represents the actual (measured) output due to quadrature only. As can be seen, the phase of the measured output signal varies between about 82° and 94°, i.e. it is not precisely constant at 90° (this ideal value is indicated by horizontal line 30).

It will be noted that the phase of the detection signal must be determined with respect to a suitable reference. Conveniently, the detection signal phase can be measured with respect to the excitation signal current; this provides a simple implementation. However, since the excitation field may lag the excitation current, a flux sensing coil may be used to provide the detection signal phase reference.

The phase difference between the excitation field and the excitation current may itself be stored. Although the precise phase of the excitation field is not needed to generate the detection signal, to obtain optimum accuracy, it is desirable to know this to enable the measurement to be aligned with the excitation to obtain optimum accuracy.

It has been appreciated pursuant to the invention that, since the cosine of a small angle is close to 1 and the gradient is close to zero, any small error in the phase angle used to “correct” the misalignment will make a much smaller difference to the measurement than failure to cancel the unwanted signal by the same amount using a conventional method. For example, a measurement error of as much as 5% will only lead to an error of the order of 0.4% and a 1 degree error will lead to an error of the order of 0.015%. Since the small change in phase of the detection signal with respect to the excitation signal has a much smaller effect on the magnitude of the wanted signal than the unwanted signal, precise measurement of this angle is therefore less critical and the small error induced by imperfect alignment may in some cases be disregarded or simply accounted for by assuming a constant value (which may be taken into account automatically during calibration).

It will be recalled that the phase of the unwanted signal with respect to the excitation signal that is significant. It is preferred to receive a physical phase reference input, such as from the excitation current or a flux sensing coil and to generate a detection signal based on this and a stored phase offset. However, in a typical modern meter where the excitation signal is itself synthesised, phase information may be available either directly or implicitly from the synthesiser which generates the excitation signal and thus a phase reference input may not be needed. Although such implicit phase information will not necessarily take into account phase shifts in output circuitry, so the phase reference may not correspond directly to the excitation phase, provided the detection signal phase is measured with respect to the same phase reference and such phase shifts are stable, this may not cause problems. In such cases

Generation and storage of detection signals can be performed, prior to actual measurement, for various frequencies. During actual measurement the detection signal can be retrieved and used in the multiplication with the output from amplifier 12.

If, during actual measurement, a frequency is used for which no detection signal had previously been generated and stored, it is possible to interpolate two detection signals corresponding to the nearest frequencies stored.

While the present invention has been described in its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

1. A method of correcting an output of an electromagnetic flowmeter which flowmeter is arranged to be excited at an excitation frequency selected from a range of possible excitation frequencies, the method comprising:
storing information concerning an estimated phase of an unwanted component of an output signal for a plurality of excitation frequencies; and
correcting the output signal to reduce the unwanted component based on the stored information concerning the phase of the unwanted component at the excitation frequency in use.

2. A method according to claim 1, wherein the stored information is derived from information stored for a particular design of flowmeter.

3. A method according to claim 1, wherein the stored information is derived by direct measurement.

4. A method according to claim 3, wherein the phase of the unwanted signal is measured during a calibration process by inserting a search coil into a bore of the flowmeter.

5. A method according to claim 3, wherein the phase of the unwanted signal is measured using flow sensing electrodes.

6. A method according to claim 1 wherein storing the information comprises sweeping the excitation frequency across a range of desired operating frequencies and recording a plurality of measures of phase of the unwanted signal across the range of frequencies.

7. A method according to claim 1 wherein, in the step of correcting the output signal, for frequencies which do not correspond exactly to a frequency for which a phase of measurement is stored, an estimated value of phase of the unwanted signal is obtained by interpolation.

8. A method according to claim 1 wherein correcting comprises measuring an electrode signal at 90 degrees to the estimated phase of the unwanted signal component based on the stored information.

9. An electromagnetic flowmeter having field generating coils for generating a magnetic field in a conduit;
a source of excitation coupled to the field generation coils arranged to produce excitation at at least one frequency;
potential sensing electrodes positioned in the conduit to sense potential developed across a fluid in the conduit; characterised by
means for storing information concerning the estimated phase of an unwanted signal component at a plurality of excitation frequencies; and
means for processing the electrode signal to reject the unwanted signal component based on the stored information.

10. A computer program or computer program product comprising instructions for performing a method according to claim 1.
